(19) United States
(12) Patent Application Publication
(10) Pub. No.: US 2007/0284407 A1
(43) Pub. Date: Dec. 13, 2007

(54) Joint-Site Structure For A Friction Welding Method And Method For Producing Said Structure

(75) Inventors: Bernhard Jutz, Burgstetten (DE); Rudolf Reinhardt, Esslingen (DE); Uwe Rohrberg, Weinstadt (DE); Patrick Schlauch, Reutlingen (DE); Hans Zechmann, Kernen (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 10/567,656

(22) PCT Filed: Jul. 29, 2004
(86) PCT No.: PCT/EP04/08490

§ 371 Date: Mar. 9, 2007

(30) Foreign Application Priority Data
Aug. 9, 2003 (DE) 103 36 668.7

(51) Int. Cl. B23K 20/12

(52) U.S. Cl. 228/2.3; 228/114.5; 29/888.08; 428/598

(57) ABSTRACT

A joint-site structure for a shaft/disk composite workpiece, in particular for joining a shaft 1 to a connection flange 2 of a hub part of the disk by means of friction welding. A respective defined gap 4, 4′ is incorporated between shaft 1 and connection flange 2 of the hub part in front of and behind a joint site 3, this gap 4, 4′ preventing the spread of the material softened during the friction welding. The joint-site structure is used, for example, during the joining of a crankshaft and a hub part of a drive wheel.

The invention relates to a joint-site structure and to a method for producing said structure according to the preambles of claims 1 and 9.

In vehicle construction, composite workpieces which are composed of a shaft and an essentially rotationally symmetrical hub part are used in numerous applications. Examples of disks are transmission and clutch parts or also disk-shaped blanks which are still to be mechanically processed.

It is known to join a shaft and hub part in a connection region by friction welding. In this case, an end face of the shaft is joined to an end face of the hub part in a conventional manner. Alternatively, the shaft and hub part can be joined by means of overlap friction welding; this involves a variant of pressure welding in which, in contrast to conventional end-face friction welding, the surfaces to be joined are arranged at the circumference of the components. In this case, for example, a shaft is welded to a hub part with overlap by one of the two components being set in rotation and being pressed onto the other stationary counterpart. The welding process starts at the contact surfaces of the components. After the plasticization of the material located there by the friction heat, a permanent joint is obtained after the end of the rotary movement.

Shown in DE 199 34 855 C1 is a friction-welded shaft/disk composite workpiece which is assembled from a disk having a through-hole and from a shaft by means of overlap friction welding. During the welding of shaft and disk, annular connection sections are produced, between which annular cavities are formed. A reduction in the weight of the entire part is achieved by the joint sites offset from one another radially and axially, it being possible for the cavities to be used, for example, for directing oil.

If a hub part of a disc is joined to a shaft by means of overlap friction welding, defects may be produced during the friction welding when the hub part is slipped onto the cold shaft, and these defects may result in notches and cracks.

The object of the invention is to specify a novel design of the joint site for a shaft/disk composite workpiece, with which design the defects are minimized and the mechanical strength properties of the joint are increased. The object of the invention is also to specify a method for producing the joint site.

The object is achieved according to the invention by the features of claims 1 and 9. Advantageous configurations can be gathered from the subclaims.

According to the invention, the joint-site structure of a shaft/hub composite workpiece, in particular for joining a shaft to a connection flange of a hub part of a drive wheel by means of friction welding, is designed in such a way that a defined gap is incorporated between the shaft and the connection flange of the hub part in front of and behind the joint site, this gap preventing the spread of the material softened during the friction welding.

Before the joining members are joined together by overlap friction welding, annular cavities (“gaps”) therefore lie between shaft and hub part, these cavities, during the friction welding, firstly receiving the softened material displaced from the joint region and secondly, on account of their small clearance height, preventing the spread of this softened material. The greater the amount of material that is forced into the cavities in the course of the upsetting phase of the friction welding, the further said material is displaced inside the cavities—starting from the actual joint site—into cooler neighboring regions of the hot joint site. In these cooler neighboring regions, the displaced material solidifies somewhat on account of the lower ambient temperature, obtains a more pasty consistency in the process and, on account of its higher viscosity, prevents the spread of the material subsequently being displaced. In the cavities, this results in the build-up of a back-pressure which results in a high density of the material forced into the gaps. This constitutes a fundamental difference from the conventional overlap friction welding, in which the pasty material in the form of a bead can readily escape from the joint site.

Since the gaps between shaft and hub part are filled with pasty material, displaced from the joint region, in the course of the friction welding operation, the composite workpiece has a widened bonding zone. Thus, for example, at a friction length of 6 mm and a clearance height of the gap of 1.5 mm, an axial extent of the bonding zone of about 10 mm is obtained. The strength of the joint is considerably increased by this axial widening of the bonding zone, since the material displaced into the gaps contributes to the welding of the joining members.

Such strength-increasing widening of the bonding zone, which occurs when the method according to the invention is used, cannot be achieved when using the conventional overlap friction welding: this is because, in order to widen the bonding zone between the joining members in conventional overlap friction welding, an increased allowance would have to be provided and the joining members would then have to be correspondingly upset to a greater extent in order to achieve the desired increased axial overlap. However, an increase in defects would accompany this greater upsetting, and these defects would reduce the strength of the joint. The fact that the effective bonding zone can be considerably widened in the manner described by the design according to the invention of the joining members and that an increase in strength is achieved in the process therefore constitutes a surprising effect.

The projection or protrusion on account of the forced-out material at the joint site is preferably machined after the friction welding in order to obtain a rounded portion.

In an advantageous configuration of the invention, a plurality of joint sites axially offset from one another are provided between shaft and hub part. In this case, it is advantageous for the self-centering and relative axial orientation of the joining members during the friction welding to offset the joint sites of the joining members axially and radially relative to one another in such a way that the joint sites of the joining members on the composite workpiece, after the welding, are arranged at an angle of between 10° to 20°, preferably 15°, to one another. The composite workpiece produced is then cylindrically symmetric.

In contrast to the end-face friction welding of the shaft to the hub part, in which conical distortion of the hub part may occur due to asymmetrical shrinkage of the hub part after the friction welding, the method according to the invention is not associated with any conical distortion of the joining members at all; the original cylindrical symmetry of the two joining members is thus retained in the composite workpiece with high accuracy.

To produce the joint-site structure according to the invention, undercuts must be provided in the radial direction on at least one of the two joining members. All the undercuts necessary for forming the joint site are advantageously provided on the shaft, so that the connection flange of the hub part has no undercuts. This is especially cost-effective from the production point of view, since the incorporation of undercuts during the machining of the shaft involves no additional outlay and a stepped tool may be used for producing the hub part, by means of which stepped tool the internal machining of the hub part is effected in a single process step.

The shaft and hub part may be made of different materials. In particular, a hardened shaft may be used, and/or the hub part may be finish-machined (hardened, ground, etc.).

If the joint region is located in the vicinity of a region of the composite workpiece that is subjected to high loading, e.g. in the vicinity of a bearing, it may be advantageous to design the shaft and the hub in such a way that the joint site is shifted radially outward, so that the region subjected to high loading is completely free of the effects of the joint site.

The gap heights of the joint sites are optimized with respect to the respective application in such a way that the diameter of the joint site, the radial overlap and the materials of the components to be joined are matched to one another. In the case of a shaft having a diameter of 60 mm, good joining results have been achieved, for example, with a gap dimension of 1.5 mm and a radial overlap of the components to be joined within the region of 1.5 to 2.5 mm, preferably 2 mm.

The invention is described below with reference to an exemplary embodiment shown in the schematic drawings. The drawings, the description and the claims contain numerous features in combination. The person skilled in the art will also expediently consider the features individually and form appropriate further combinations therefrom.

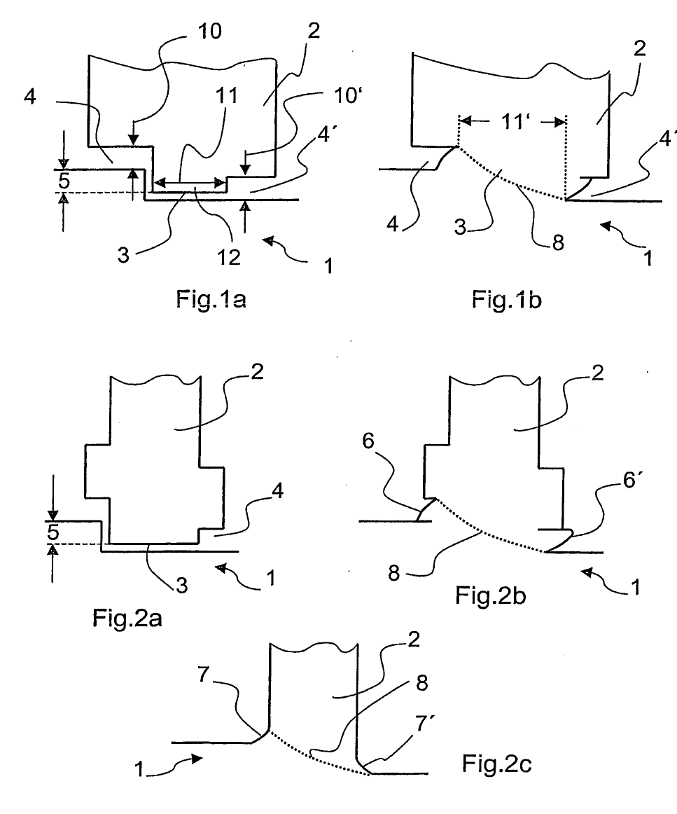

FIGS. 1a, 1b show a shaft/disk composite workpiece with a one-step connection flange.

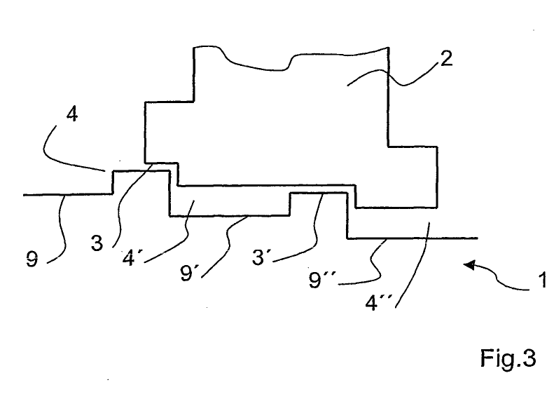

FIGS. 2a, 2b, 2c show the structure of the joint site of a one-step connection flange.

FIG. 3 shows a shaft/disk composite workpiece with a two-step connection flange.

According to FIG. 1a, a shaft 1, e.g. a crankshaft, is joined to a disk, e.g. a hub part of a drive wheel having a connection flange 2. By end extensions on the front and rear sides of the connection flange 2, a respective defined gap 4, 4′ having a clearance height 10, 10′ is incorporated in front of and behind the joint site 3. In the assembled position of the shaft 1 with the connection flange 2, these gaps 4, 4′ form annular cavities. The radial overlap 5 of shaft 1 and connection flange 2 is, for example, 2 mm. Due to the friction welding, the heated, soft material attempts to escape from the joint site 3, but is prevented from doing so in the radial direction by the gap 4, 4′. This leads to a bonding zone 8 between shaft 1 and connection flange 2, the effective width 11′ of this bonding zone 8 being increased compared with the width 11 of a web 12 originally provided on the connection flange 2 at the joint site 3. The structure of the joint site of a one-step connection flange is shown in FIG. 2. A projection or protrusion 6, 6′ of the material of the joint site is obtained after the friction welding, and this projection or protrusion 6, 6′ is machined, for example, after the friction welding in order to obtain a rounded portion 7, 7′.

FIG. 3 shows a two-step connection flange 2. Between the shaft 1 and the connection flange 2, a respective gap 4, 4′, 4″ is provided in the axial direction in front of and behind the joint sites 3, 3′. The gap 4′, into which material softened during the friction welding penetrates from both joint sites 3, 3′, is dimensioned with regard to its height and length in such a way that material displaced from the joint site 3 does not impair the material flow from joint site 3′. In this exemplary embodiment, the two-step connection flange 2 of the hub part has no undercuts at all in the radial direction; the undercuts 9, 9′, 9″ required for forming the joint sites 3, 3′ are all provided on the shaft 1.

The joint-site structure according to the invention is used, for example, during the joining of a crankshaft to a drive wheel.

To produce a composite workpiece of a crankshaft 1 for a motor vehicle having a connection flange 2 of a hub part of a drive wheel, first of all a one-piece hub unit—comprising the hub part of the drive wheel and the connection flange—is produced. Between the crankshaft and the connection flange of the hub unit, a respective defined gap is incorporated in front of and behind the joint side provided, this gap preventing the spread of the material softened during the subsequent joining of crankshaft and connection flange by friction welding.

To machine the regions of the hub part which face the shaft, a stepped tool is used, so that the internal machining of the hub is carried by means of a single tool in a single process step.

During the friction welding, the drive wheel can be cooled in order to avoid, for example, the annealing of a hardened tooth system, provided on the drive wheel, during the friction welding.

1-12. (canceled)

13. A joint-site structure for a shaft/hub composite workpiece for joining a shalt to a connection flange of a hub part using friction welding, the structure comprising:
a material filling a respective gap between the shaft and the connection flange of the hub part in front of and behind a joint site, the gap preventing spread of the material softened during the friction welding, and a height of the gap being dimensioned in such a way that the composite workpiece, in front of and behind the joint site, has a bonding zone widened relative to a width of a web originally provided on the connection flange section.

14. The joint-site structure as recited in claim 13 wherein at a friction length of 6 mm and a gap distance of 1.5 mm, the bonding zone has an axial extent of 10 mm.

15. A friction-welded shaft and hub combination comprising:
a shaft;
a hub having a connection flange; and
a material filling a respective gap between the shaft and the connection flange of the hub part in front of and behind a joint site, the gap preventing spread of the material softened during the friction welding, and a height of the gap being dimensioned in such a way that the combination, in front of and behind the joint site, has a bonding zone widened relative to a width of a web originally provided on the connection flange section.

16. The combination as recited in claim 15 wherein the connection flange is a a two-step connection flange having no undercuts.

17. The combination as recited in claim 15 wherein the shaft has undercuts.

18. The combination as recited in claim 15 wherein the shaft and the hub are made of different materials.

19. The combination as recited in claim 15 wherein the shaft and hub to be joined have a radial overlap in a region of 1.5 to 2.5 mm.

19. The combination as recited in claim 15 wherein the shaft or hub is a crankshaft and the other of the shaft or hub is a drive wheel.

20. A method of joining a shaft to a connection flange of a hub part comprising:
providing a respective defined gap between the shaft and the connection flange in front of and behind a joint site,
subsequently friction welding material in the gap, the gap preventing a spread of the material softened during the friction welding and building up a back-pressure resulting in a high density of the material forced into the gaps.

21. The method as recited in claim 20 wherein the shaft is a crankshaft for a motor vehicle and the hub part is a drive wheel.

22. The method as recited in claim 21 wherein the drive wheel is cooled during the friction welding.

23. The method as recited in claim 20 wherein the hub part is produced without undercuts, and undercuts required for forming the connection flange are produced on the shaft.

24. The method as recited in claim 20 further comprising using a stepped tool for producing the hub part, and an internal machining of the hub is carried out in one process step.
